(19) United States
(12) Patent Application Publication
(10) Pub. No.: US 2019/0244364 A1
(43) Pub. Date: Aug. 8, 2019

(54) System and Method for Detecting the Object Panic Trajectories

(71) Applicant: OOO ITV Group, Moscow (RU)

(72) Inventors: Murat K. Altuev, Chernogolovka (RU); Viacheslav V. Bratishchev, Moscow (RU)

(21) Appl. No.: 16/167,535

(22) Filed: Oct. 23, 2018

(30) Foreign Application Priority Data
Feb. 6, 2018 (RU) 2018104556

(51) Int. Cl. G06T 7/20; G08B 5/22; G08B 3/10

(52) U.S. Cl. CPC G06T 7/20; G08B 5/22; G06T 2207/20096; G06T 2207/30241; G08B 3/10

(57) ABSTRACT

The invention relates to the area of safety and monitoring systems, and more particularly to the technologies aimed to detect the alarming object trajectories afield while using the specified graphics primitives. The computer system detecting the alarming object trajectories consists of the processor, memory, data capture device and graphical user interface. The data input means include the graphics primitives setting unit configured to set the graphics primitive by choosing several points in the coordinates system of original data. The set of specified graphics primitives internally forms the tracing area, the classification rules setting unit and object trajectory classification unit. The object trajectory classification unit is additionally designed with the possibility to set the notifications to user. The enlargement of hardware range relating to the alarming object trajectories detection is achieved.

### RELATED APPLICATIONS

This application claims priority to Russian Patent Application RU 2018104556, filed Feb. 6, 2018, which is incorporated herein by reference in its entirety.

### FIELD OF THE INVENTION

The invention relates to the area of safety and surveillance systems, and more particularly to the technologies aimed to detect the alarming object trajectories afield while using the specified graphics primitives.

### BACKGROUND

The surveillance systems may be used for premises and territories supervision. Such systems generally use the video surveillance cameras to identify and track the object motions within the protected area. For example, the video surveillance cameras may be used to detect the unauthorized access of people or transport to the protected territory. The most surveillance systems may generate the alert signal because of the presence of moving object within the controlled area.

The tasks, which may be solved by means of surveillance systems, embrace the following ones: objects detection, objects motion tracking, objects classification, objects identification, detection or identification of different situations including the alarming etc.

Let's suppose that there is a location map with the object trajectories on it received from automobiles' GPS sensors. The operator obtains the information about alarm event if some automobile drives along the unauthorized route or drives into the forbidden region etc. The alarm event also supposes the presence of one or another object both motionless and moving (in particular their location, trajectory and many other features). The object may be a person, animal, transport (automobile, bicycle) or any things moving within the field of view of video surveillance cameras or sensors.

Moreover, the operator may be interested in the object trajectories, which due to some definite criteria became more interesting than other. For example, the trajectory of one object may change its direction becoming alarming. In case of automobiles, the trajectories, which are on the corporate territory for a long time, may be interesting because sometimes this could demonstrate the potential theft.

To optimize the process of detecting the alarming object trajectories there are different technologies such as setting of classification rules of object trajectories in order to refer the latter to the alarming.

From the field of invention, the invention disclosed in the patent CA 2545535 C, issued Jan. 26, 2016, is known in which the graphical user interface of video surveillance system allows the user to set the video ‘lengthening’. At the same time, the interference detection of object trajectory and ‘lengthening’ are used as one of the rules for detecting the alarming trajectories. This technology even provides an opportunity to set the ‘lengthening’ and some simple rules for detecting the alarming object trajectories, but it doesn't allow to set more complex rules for detecting the alarming trajectories and carrying out the trajectory classification. Moreover, this invention is restrictively aimed only at the video processing and doesn't mean the processing of data flow received from the sensors.

Additionally, the invention disclosed in the application US 20150242691 A1, published Aug. 27, 2015, is known. It describes the monitoring system characterized by several present sensors for territory control. The system provides an opportunity to set the tracing area and alarm criteria for the objects, as well as track the objects and identify if the object disturbed the specified alarm criteria while using the received data. The disadvantage of such invention consists in the inability to set the graphics primitives and absence of the possibility to set the classification rules exclusively for the object trajectories.

### BRIEF SUMMARY

The invention is aimed at eliminating the drawbacks of the older-level equipment and developing the already known inventions.

The technical result of the claimed group of inventions is a broader range of technical means regarding the detecting of alarming object trajectories by setting the graphics primitives and testing every object trajectory for anxiety according to the rules related to the specified graphics primitives.

This technical result is achieved due to the fact that computer system detecting the alarming object trajectories includes at least one processor; memory unit designed with the possibility to store the original data; minimally one data capture device configured to collect and provide the data flow including the object metadata where the latter comprise at least information about the number of object locations at the certain points; graphical user interface designed with the possibility to process the object metadata and possesses the means of data input and output (the data input means embrace the graphics primitives setting unit configured to set at least one graphics primitive by choosing several points in the coordinates system of original data connected with the data flow coming from the data capture device, and the specified graphics primitives internally form the tracing area; classification rules setting unit designed with the possibility to set the rules identifying which of object trajectories are alarming in relation to the tracing area; object trajectory classification unit configured to check every trajectory according to the rules specified in the classification rules setting unit to detect the alarming object trajectories, and the object trajectory classification unit is designed with the possibility to send the notifications to user if the trajectory turned out to be or became alarming during the specified time).

The specified technical result is also achieved due to the method for detecting the alarming object trajectories realized by the computer system and embracing the stages during which the data flow including objects metadata are collected and introduced (the metadata comprise at least information about the number of object locations at the certain points); minimally one graphics primitive is set by choosing several points in the coordinates system of original data relating to the data flow coming from the data capture device (here the number of specified graphics primitives internally forms the tracing area); the classification rules defining which object trajectories are alarming in relation to the tracing area are set; every trajectory is checked according to the specified classification rules in order to detect the alarming object trajectories; and notification is sent to the user if the trajectory turned out to be or became alarming during the specified time.

In one possible implementation of the invention, the original data may be the location map or image received from the data capture device, and the location map may be bound to the data flow.

In one more possible implementation of the invention, the user interface is additionally configured to display the object coordinates on the original data.

In another possible implementation of the invention, the object coordinates may be two- or three-dimensional ones.

In one more possible implementation of the invention, the data flow is represented by the video or object metadata stream.

In another possible implementation of the invention, the graphics primitive may be a virtual two- or three-dimensional surface.

In one more possible implementation of the invention, two-dimensional surface is at least one of the following: segment, straight line, curve line, broken line, polyline, arc.

In another possible implementation of the invention, three-dimensional surface is at least one of the following: plane, broken surface, smoothly spun surface, multi-segment surface.

In one more possible implementation of the invention, the graphics primitives taken from the set of graphics primitives may be located arbitrary, in parallel or at selected angle relative to each other.

In another possible implementation of the invention, the tracing area is a corridor constrained by the specified graphics primitives.

In one more possible implementation of the invention, the fact of complete object passing through the corridor due to the set trajectory fully located inside the corridor is related to the classification rule.

In another possible implementation of the invention, the fact of complete object passing through several specified corridors in succession due to the trajectories which are set for every corridor and fully located inside every of several mentioned corridors is related to the classification rule.

In one more possible implementation of the invention, the following object parameters are minimally set by the classification rules setting unit in the course of classification rules setting: trajectory, type, color, minimum allowed speed, maximum allowed speed, minimum permissible dimension, maximum permissible dimension.

In another possible implementation of the invention, the types of object relate to: person, group of people or transport.

In one more possible implementation of the invention, it is possible to minimally set the object's sex or possession of one of the things (bag, umbrella, headwear, moustaches, beard) as additional characteristics.

In another possible implementation of the invention, the classification rules additionally depend on the type of data capture device that provides the metadata.

In one more possible implementation of the invention, one of the following things may represent the data capture device: video surveillance camera, GPS sensor, GLONASS sensor, objects detector.

In another possible implementation of the invention, the data capture device is a security system bracelet providing GPS or GLONASS coordinates. At the same time, this device alerts the bracelet's possessor identifier and due to the type of this identifier determines if it is necessary to alert.

In one more possible implementation of the invention, the user notification may be at least visual, acoustic, textual or combined.

In another possible implementation of the invention, the memory unit is additionally designed with the possibility to record and store the data archive received from at least one data capture device. At the same time, the computer system is additionally configured to detect the alarming trajectories using the archive data.

This technical result is achieved due to a computer-readable data carrier comprising instructions executable by the computer processor for implementing variants of methods for detecting the alarming object trajectories.

### BRIEF DESCRIPTION OF THE SEVERAL VIEWS OF THE DRAWINGS

FIG. 1 is a block diagram of a system for detecting the alarming object trajectories;

FIG. 2 is an example of tracing area in the form of corridor constrained by the graphics primitives;

FIG. 3 is a block diagram of one of variants to implement the method for detecting the alarming object trajectories.

### DETAILED DESCRIPTION

Below, the description of possible implementation of the claimed group of inventions is provided. However, the claimed group of inventions is not limited to only these implementations. It will be obvious to experts that other implementation variations may be included within the scope of the claimed group of inventions described in the formula.

In its implementation variations, the invention can be executed in a form of computer systems and methods for detecting the alarming object trajectories, as well in the form of computer-readable data carrier.

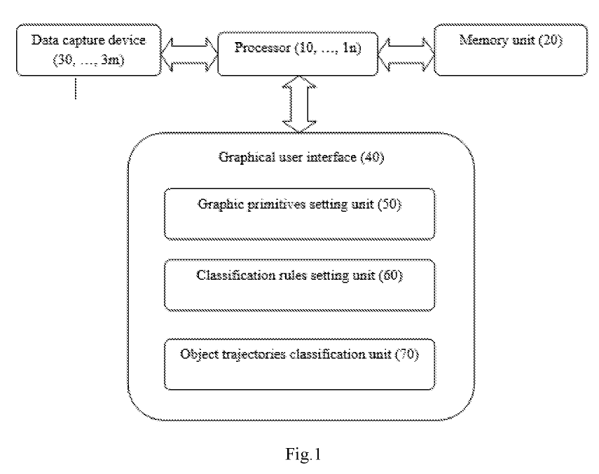

FIG. 1 shows a block diagram of one of variants to implement the system for detecting the alarming object trajectories. The base case system includes: at least one processor (10, . . . , 1n); memory unit (20); at least one data capture device (30, . . . , 3n); and a graphical user interface (40) which comprises: graphics primitives setting unit (50), classification rules setting unit (60), and object trajectory classification unit (70). These user interface units are data input means, while the user interface includes also data output means (not shown).

In this context, systems are any computing systems built based on software and hardware, such as: personal computers, smartphones, laptops, tablets, etc.

Processor of computer system in certain implementations can be replaced by: a microprocessor, a computer (electronic computer), a PLC (programmable logic controller) or integrated circuit.

The following items can (but not limited to) act as a memory device: hard drives (HDD), a flash memory, a ROM (read-only memory), solid-state stores (SSD), etc.

Any computing devices, which can provide the object metadata, are considered to be the data capture devices. The data capture device may be one of the following: video surveillance camera, GPS sensor, GLONASS sensor, objects detector. In some implementations, the security system bracelet providing GPS may represent the data capture device or GLONASS coordinates.

Graphical User Interface (GUI) represents a system of means for user interaction with the computer system based on representation of all system objects and functions available to the user in a form of graphical components of the screen (windows, icons, menus, buttons, lists, etc.). At the same time, the user has random access (by means of input devices) to all visible display objects-interface units, which are displayed on the display (monitor). The user input device can be represented by, but is not limited to, for example, a mouse, a keyboard, a touchpad, a stylus, a joystick, a trackpad, etc.

It should be noted that this computer system might include any other devices known in this field of inventions.

Next, an example of the above-mentioned computer system of detecting the alarming trajectories will be described. At the same time, some terms and their definitions mentioned below will be used.

Data flow—an information received from the data capture device and including the objects metadata.

Original data—a location map or image (screenshot, picture) received from the data capture devices in advance.

Tracing area—an area constrained by the graphics primitives.

The operation of computer system is begun with the receiving of data flow by at least one data capture device. The data flow contains the objects metadata, and metadata minimally comprise the set of object locations (coordinates) at the certain points. The data flow may be represented by the video stream if the data capture device is a video surveillance camera, or object metadata stream if the data capture device is a sensor or objects detector.

It is necessary to admit that computer system memory unit stores the original data, which may be the location map or image (screenshot) due to the type of data capture device. If the data are received from the sensors, the flow of incoming data is bound to the location map.

Furthermore, the received data flow enters the graphical user interface for objects metadata processing. In some system versions, the user interface is designed with the possibility to represent the object coordinates on the original data that allows operator to more graphically estimate and control the situation within the protected area. The object coordinates may be two- or three-dimensional ones due to the method of data representation chosen by operator. As it was mentioned before, the graphical user interface includes the data input and output means that ensure the user interaction.

To set the graphics primitives the operator activates the graphics primitives setting unit. In the context of given description, the graphics primitive is a virtual two- or three-dimensional surface. Here one of the following minimally represents two-dimensional surface: segment, straight line, curved line, broken line, polyline, arc. Three-dimensional surface is at least: plane, broken surface, smoothly spun surface, multi-segment surface etc.

Using this unit, the operator may set one or several graphics primitives through choosing several points in the coordinates system of original data. For this purpose, the operator can use the data-input device such as computer mouse. If the original data are represented by the location map the operator (or computer system user) may see the territory of secured facility (or monitor object) and arrange the graphics primitives in the way to detect the alarming object trajectories within the protected area in the best way. In this case, the object coordinates are laid on the location map, and operator observes the movement of all objects within the protected area. The same work is carried out in case of video data shown on display.

The operator is able to set several graphics primitives, i.e. the set forming the tracing area. For example, the operator can set two graphics primitives in the form of segment, which are parallel with each other. Then the area between them will be the tracing area. Nevertheless, even one set graphics primitive forms the tracing area in relation to which the object trajectories are analyzed.

If setting the number of graphics primitives, the operator is limited in the way to arrange them in no case. This means that primitives may be placed absolutely at random relative to each other, or some rules set by the operator in settings may be observed. For example, the graphics primitives may be placed in parallel in some versions. In other versions, the user may set the definite angle at which the graphics primitives will be located.

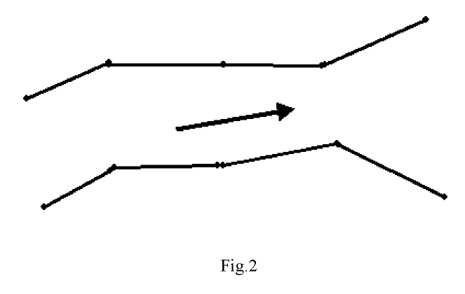

As previously noted, the set of graphics primitives may set the tracing area. As example, FIG. 2 shows the tracing area, which forms the corridor constrained by several graphics primitives. There is an arrow inside the corridor that shows the necessary object trajectory in order that such trajectory was deemed to be alarming. If the object passes the set corridor in other direction, the system won't respond to such object trajectory.

Furthermore, using the classification rules setting unit the operator is able to set the certain rules for defining which of object trajectories may be considered as alarming in relation to the specified tracing area.

At the early stage the classification rules setting unit ensures the operator with an opportunity to set at least the following object parameters: trajectory, type, color, minimum allowed speed, maximum allowed speed, minimum permissible dimension, maximum permissible dimension. The object type examples are person, group of people or transport. Moreover, it is possible to set the additional object characteristics such as object sex or minimal presence of one of the following articles: bag, umbrella, headwear, moustaches and beard. These parameters may be set partially or completely for more detailed and exact classification of object trajectories. It is necessary to understand that classification rules additionally depend on the type of data capture device that provides the metadata. For example, if the data capture device is a video surveillance camera it is necessary to consider the object color.

If the necessary parameters are set, the operator will assign the certain object trajectory classification rules. For example, the simple rules may include: the fact of entering (appearance) of the trajectory of at least one object into the tracing area; the fact of escaping (disappearance) of the trajectory of at least one object from the tracing area; fact of object movement start; fact of object stop; identification of time when the trajectory of at least one object stays within the specified tracing area. Moreover, it is possible to set the rules due to which the object trajectory would cross all set graphics primitives in the definite order or within the certain period of time in the computer system.

More complicated rules embrace the fact of complete passing of tracing area by the object (for example, passing through the corridor due to specified direction following the trajectory which is completely located inside the corridor). One more rule is a fact of complete passing of object through several specified corridors in succession due to the trajectories which are set for every corridor and fully located inside every of several mentioned corridors. For example, there is a protected enterprise with numerous rooms and corridors. To enter the warehouse, the object, i.e. person, should get through three corridors set by operator in the specific sequence and direction to turn his trajectory into alarming. If the person got only through two of specified corridors and then turned or moved to the third corridor following another direction, the trajectory of this person won't be considered alarming. Such approach, namely the setting of several corridors excludes the false definition of trajectories as alarming. It is necessary to admit that other rules or any combinations of the rules mentioned above which are not limited by the previously mentioned examples, may be set in the rules setting unit.

When the classification rules are set, and data flow is received, the computer system begins to classify the object trajectories by means of the object trajectory classification unit. The object trajectory classification unit checks every trajectory according to the specified rules to detect the alarming object trajectories. The checking functions may be adjusted in accordance with the certain fact and/or several facts at once, which can give evidence of present alarm signs for one or another object trajectory. At the same time, the system features the opportunity to assign the apprehension degree for the alarming trajectories: high, average, low, false.

Moreover, the object trajectory classification unit is additionally designed with the possibility to send the notifications to the user if the trajectory turned out to be or became alarming during the specified time. Such notifications may be at least visual, acoustic, textual or combined. The user and/or operator may set the time and type of notification eligible for him with the help of user interface. For example, if the object trajectory became alarming during the specified time (e.g. 15 minutes) the user would immediately receive the notification about it. The user notification may be in the form of SMS or MMS with the indication of specific object parameters with the alarming trajectory.

If the data capture device is a security system bracelet providing GPS or GLONASS coordinates of the object, the device may report the name of bracelet possessor to the computer system upon which it identifies if it is necessary to notify about the alert.

Although the operation of computer system was described with the account that data flow is received in real time and object trajectory classification is carried out on a real time basis but sometimes it is necessary to track the trajectories due to archive data. For these reasons, the memory unit of computer system is configured to record and store the archive data received from the data capture devices, and the computer system is additionally configured to detect the alarming trajectories with the help of archive data.

For example, some protected enterprises do not have 24-hour security. In other words, the operator follows the actions only during the daytime. In this case, the computer system may daily perform the complete check of archive data received from the data capture devices at nighttime. Moreover, the operator may adjust the specific time of data analysis so that the system could carry out the analysis of archive data with respect to the alarming object trajectories every day at 8 a.m. The other example describes the case when security provider began to protect another territory. If this territory was equipped with, the data capture devices it will be possible to analyze the object trajectories within the required time interval (for example, the day or month when the theft or other violation was supposed to happen) with the help of described computer system using the stored archive data.

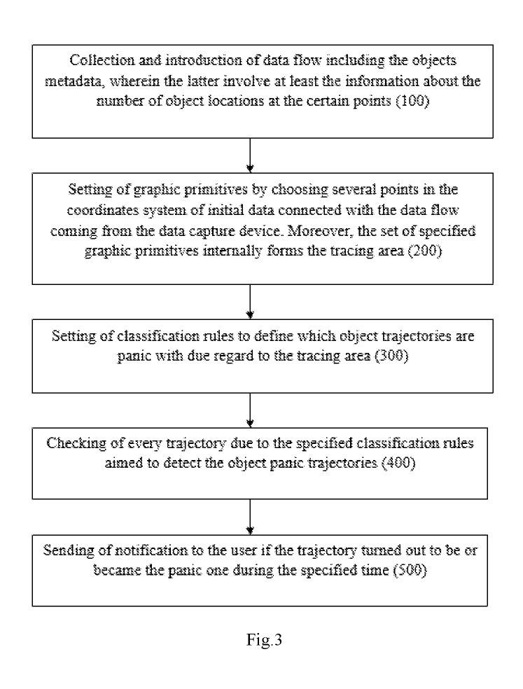

FIG. 3 shows the block diagram of one of variants to implement the method for detecting the alarming object trajectories. The mention method embraces the stages during which:

(100) the data flow including objects metadata are collected and introduced (the metadata comprise at least the information about the number of object locations at the certain points);

(200) minimally one graphics primitive is set by choosing several points in the coordinates system of original data relating to the data flow coming from the data capture device (here the number of specified graphics primitives internally forms the tracing area);

(300) the classification rules defining which object trajectories are alarming in relation to the tracing area are set;

(400) every trajectory is checked according to the specified classification rules in order to detect the alarming object trajectories; and

(500) notification is sent to the user if the trajectory turned out to be or became alarming during the specified time.

It should be noted that this method can be implemented through the use of a computer system and, therefore, it can be expanded and specified by all the possible implementations that have already been described above for implementing the computer system.

In addition, possible implementations of this group of inventions can be implemented with use of software, hardware, software logic, or their combination. In this exemplary implementation, the program logic, software, or instruction set is stored in one of the conventional computer-readable media, i.e., a computer-readable data carrier.

In the context of this document, a “computer-readable data carrier” can be any medium or means that can comprise, store, transmit, distribute, or transport instructions (commands) that can be used by a computer system such as a computer. The computer-readable data carrier may be a non-volatile computer-readable storage medium.

One of the examples of the invention implementation may offer the scheme of user interface configured to ensure at least some functions of control described above.

If necessary, at least part of the various operations viewed in the description of this invention can be performed in a manner different from the presented order and/or simultaneously with each other.

Although this technical invention has been described in detail to illustrate the most popular and currently preferred implementations, it is to be understood that the invention is not limited to the disclosed implementations, and moreover, is intended to be modified and combined with other implementations. For example, it is necessary to understand that the present invention assumes that, to the possible extent, one or more of the features of any possible implementations may be combined with one or more features of any other implementation.

1. A computer system for detecting the alarming object trajectories that includes:
at least one processor;
a memory unit configured to store original data;
at data capture device configured to collect and output data including object metadata,
wherein the metadata comprise, for specific times, object coordinates;
a graphical user interface configured to process the object metadata;
a data input unit; and
a data output unit;
wherein the data input unit comprises:
a graphics primitives setting unit configured for a user to choose at least one graphics primitive by choosing points in coordinates of the original data output by the data capture device,
wherein the at least one graphics primitive forms a tracing area;
a classification rules setting unit configured to define rules for determining whether an object trajectory is alarming with respect to the tracing area;
an object trajectory classification unit configured to detect alarming object trajectories according to the rules defined in the classification rules setting unit;
wherein the object trajectory classification unit is further configured to send a notification to the user if an alarming object trajectory is detected.

2. The computer system of claim 1, wherein the original data comprise a location map output by the data capture device or image data output by the data capture device.

3. The computer system of claim 2, wherein the graphical user interface is further configured to display object coordinates in the original data.

4. The computer system of claim 3, wherein object trajectory coordinates are two-dimensional or three-dimensional.

5. The computer system of claim 1, wherein the output data is a video or an object metadata stream.

6. The computer system of claim 1, wherein the at least one graphics primitive is a two- dimensional surface or a three-dimensional surface.

7. The computer system of claim 6, wherein the two-dimensional surface is one of: a segment, a straight line, a curved line, a broken line, a polyline, and an arc.

8. The computer system of claim 6, wherein the three-dimensional surface is one of: a plane, a broken surface, a smooth curved surface, and a multi-segment surface.

9. The computer system of claim 1, wherein the at least one graphics primitive is located arbitrarily, in parallel or at selected angle relative to each other.

10. The computer system of claim 1, wherein the tracing area is a corridor constrained by the specified graphics primitives.

11. The computer system of claim 10, wherein the fact of object complete passing through the corridor due to the set trajectory fully located inside the corridor is related to the classification rule.

12. The computer system of claim 10, wherein the fact of object complete passing through several specified corridors in succession due to the trajectories which are set for every corridor and fully located inside every of several mentioned corridors is related to the classification rule.

13. The computer system of claim 1, wherein the following object parameters are minimally set by the classification rules setting unit in the course of classification rules setting: trajectory, type, color, minimum allowed speed, maximum allowed speed, minimum permissible dimension, maximum permissible dimension.

14. The computer system of claim 13, wherein the type of object relates to: person, group of people or transport.

15. The computer system of claim 13, wherein it is possible to minimally set the object's sex or possession of one of the things (bag, umbrella, headwear, moustaches, beard) as additional characteristics.

16. The computer system of claim 1, wherein the classification rules additionally depend on the type of data capture device that provides the metadata.

17. The computer system of claim 16, wherein one of the following may represent the data capture device: video surveillance camera, GPS sensor, GLONASS sensor, objects detector.

18. The computer system of claim 16, wherein the data capture device is a security system bracelet providing GPS or GLONASS coordinates. At the same time, this device alerts the bracelet's possessor identifier and due to the type of this identifier determines if it is necessary to alert.

19. The computer system of claim 1, wherein the user notification may be at least visual, acoustic, textual or combined.

20. The computer system of claim 1, wherein the memory unit is additionally designed with the possibility to record and store the data archive received from, at least, one data capture device, and the computer system is additionally configured to detect the alarming trajectories using the archive data.

21. A method for detecting alarming object trajectories is realized by the computer system and includes the stages during which:
the output data including objects metadata are collected and introduced and metadata involve, at least, the information about number of object locations at the certain points;
at least one graphics primitive is set by means of choosing several points in the coordinates system of original data connected with the output data coming from the data capture device. Moreover, the set of specified graphics primitives internally forms the tracing area;
the classification rules defining which object trajectories are alarming in regards to the tracing area are set;
every trajectory is checked according to the specified classification rules to detect the alarming object trajectories; and
the notification is sent to the user if the trajectory is turned to be or became alarming during the specified time.

22. The method of claim 21, wherein the original data may be the location map or image received from the data capture device, and the location map may be bound to the output data.

23. The method of claim 21, wherein it is additionally designed with the possibility to induce the user interface to display the object coordinates on the original data.

24. The method of claim 23, wherein the object coordinates may be two- or three-dimensional ones.

25. The method of claim 21, wherein the output data is represented by the video or object metadata stream.

26. The method of claim 23, wherein the graphics primitive may be the virtual two- or three-dimensional surface.

27. The method of claim 26, wherein two-dimensional surface is at least one of the following: segment, straight line, curve line, broken line, polyline, arc.

28. The method of claim 26, wherein three-dimensional surface is at least one of the following: plane, broken surface, smoothly spun surface, multi-segment surface.

29. The method of claim 26, wherein the graphics primitives taken from the set of graphics primitives may be located arbitrary, in parallel or at selected angle relative to each other.

30. The method of claim 21, wherein the tracing area is a corridor constrained by the specified graphics primitives.

31. The method of claim 30, wherein the fact of complete object passing through the corridor due to the set trajectory fully located inside the corridor is related to the classification rule.

32. The method of claim 30, wherein the fact of complete object passing through several specified corridors in succession due to the trajectories which are set for every corridor and fully located inside every of several mentioned corridors is related to the classification rule.

33. The method of claim 21, wherein the following object parameters are minimally set in the course of classification rules setting: trajectory, type, color, minimum allowed speed, maximum allowed speed, minimum permissible dimension, maximum permissible dimension.

34. The method of claim 33, wherein the person, group of people or transport belongs to the types of object.

35. The method of claim 33, wherein it is possible to minimally set the object's sex or possession of one of the things (bag, umbrella, headwear, moustaches, beard) as additional characteristics.

36. The method of claim 21, wherein the classification rules additionally depend on the type of data capture device that provides the metadata.

37. The method of claim 36, wherein one of the following things may represent the data capture device: video camera, GPS sensor, GLONASS sensor, objects detector.

38. The method of claim 36, wherein the data capture device is a security system bracelet providing GPS or GLONASS coordinates. At the same time, this device alerts the bracelet's possessor identifier and due to the type of this identifier determines if it is necessary to alert.

39. The method of claim 21, wherein the user notification may be at least visual, acoustic, textual or combined.

40. The method of claim 21, wherein it is additionally designed with the possibility to record and store the data archive received from at least one data capture device, and computer system is additionally configured to detect the alarming trajectories using the archive data.

41. The storage medium read by the computer contains the instructions performed by the processor to implement the methods of claim 21.
